(19) United States
(12) Patent Application Publication
(10) Pub. No.: US 2015/0346553 A1
(43) Pub. Date: Dec. 3, 2015

(54) BACKLIGHT MODULE AND LIQUID CRYSTAL DISPLAY DEVICE

(71) Applicant: Shenzhen China Star Optoelectronics Technology Co., Ltd., Shenzhen, Guangdong (CN)

(72) Inventors: Shihhsiang Chen, Shenzhen (CN); Yuchun Hsiao, Shenzhen (CN); Chengwen Que, Shenzhen (CN)

(73) Assignee: Shenzhen China Star Optoelectronics Technology Co., Ltd., Shenzhen, Guangdong (CN)

(21) Appl. No.: 14/363,796

(22) PCT Filed: May 30, 2014
(86) PCT No.: PCT/CN2014/078901

§ 371 Date: Jun. 7, 2014

(30) Foreign Application Priority Data
May 27, 2014 (CN) 201410226693.6

(51) Int. Cl. G02F 1/1335; F21V 9/14; G02F 1/1368

(52) U.S. Cl. CPC G02F 1/133615; G02F 1/1368; G02F 1/133514; G02F 1/133528; G02F 1/13362; G02F 1/133553; F21V 9/14; F21Y 2101/02

(57) ABSTRACT

The present invention relates to a backlight module including: a rear plate; a reflective sheet disposed on the rear plate; a glass substrate disposed on the reflective sheet, a surface of the glass substrate facing the reflective sheet being formed with an optical dot structure layer and another surface of the glass substrate acting as a light exiting surface; and a backlight source disposed at a side of the glass substrate. The backlight source and the glass substrate have a first polarizer disposed therebetween and thereby light emitted from the backlight source becomes a polarized light after passing through the first polarizer, subsequently enters into the glass substrate and then exits out from the light exiting surface after being reflected by the optical dot structure layer. Moreover, the present invention further discloses a liquid crystal display device including the above backlight module.

### TECHNICAL FIELD

The present invention relates to the field of liquid crystal display, and particularly to a backlight module and a liquid crystal display device including such a backlight module.

### DESCRIPTION OF RELATED ART

A liquid crystal display device, or referred as to LCD device, is a type of thin flat display device and includes a certain amount of color pixels or monochrome pixels disposed on the front of a light source or a reflective plate. The LCD device is popular to people and has became a mainstream of the display field due to its advantages of low power consumption, high image quality, small size and light weight.

Generally, a liquid crystal display device includes a liquid crystal display screen and a backlight module. The liquid crystal display screen is disposed opposite to the backlight module. The backlight module provides a display light to the liquid crystal display screen for facilitating the liquid crystal display screen to display an image. The liquid crystal display screen mainly is constituted of two transparent substrates and liquid crystal molecules sealed between the two transparent substrates. Currently, the liquid crystal display device generally adopts a thin film transistor (TFT) liquid crystal display screen, and the backlight module can be classified as direct-type and edge-type according to the location of light source thereof. FIG. 1 is a schematic structural view of conventional backlight module and liquid crystal display screen. As shown in FIG. 1, the backlight module mainly includes a rear plate, a reflective sheet, a light guide plate and an optical film set arranged in that order. A backlight source is disposed at a side of the light guide plate. Light rays emitted from the backlight source are changed with propagation directions and uniformed as much as possible by the light guide plate and the optical film set, and then emit out from the top of the optical film set into the liquid crystal display screen.

The backlight module illustrated in FIG. 1 employs the light guide plate and corresponding relatively large-area optical films, the prices of the light guide plate and the optical films are high, and materials of the light guide plate and the optical films are prone to damage and deformation which would cause degraded display of the liquid crystal display device. Furthermore, the light rays would be attenuated during propagating in the light guide plate and the optical film set, resulting in the reduction of light utilization efficiency of the liquid crystal display device. Accordingly, on the prerequisite of achieving backlight effect, it is necessary to take in consideration of reducing optical paths of the light rays propagating in the light guide plate and the optical film set as much as possible.

### SUMMARY

In order to solve the problems in the prior art, the present invention provides a backlight module. The backlight module no longer uses the conventional light guide plate and thus the cost of product is reduced. Moreover, the backlight module further can increase the utilization efficiency of light source and thereby the quality of product is improved.

In order to achieve the above objective, the present invention proposes the following technical schemes.

Specifically, a backlight module includes: a rear plate, a reflective sheet, a glass substrate and a backlight source. The reflective sheet is disposed on the rear plate. The glass substrate is disposed on the reflective sheet. A surface of the glass substrate facing the reflective sheet is formed with an optical dot structure layer, and another surface of the glass substrate acts as a light exiting surface. The backlight source is disposed at a side of the glass substrate. The backlight source and the glass substrate have a first polarizer disposed therebetween. Light emitted from the backlight source becomes a polarized light after passing through the first polarizer, subsequently enters into the glass substrate and then exits out from the light exiting surface after being reflected by the optical dot structure layer.

In an exemplary embodiment, the first polarizer is pasted to the side of the glass substrate.

In an alternative exemplary embodiment, the first polarizer is fixed at the side of the glass substrate with a certain distance by a fastener.

In an exemplary embodiment, the optical dot structure layer is formed on the glass substrate by a printing process or an etching process.

In an exemplary embodiment, the first polarizer and the backlight source have an optical film set disposed therebetween.

In an alternative exemplary embodiment, the first polarizer and the glass substrate have an optical film set disposed therebetween.

In an exemplary embodiment, the optical film set is selected from the group consisting of a diffuser sheet, a prism sheet, an anti-reflective film, and any combinations thereof.

In an exemplary embodiment, the backlight source includes multiple light emitting diodes.

In another aspect, the present invention provides a liquid crystal display device including a liquid crystal display screen and a backlight module. The liquid crystal display screen at least includes a TFT glass substrate, a liquid crystal layer, a color filter glass substrate and a second polarizer arranged in that order. The backlight module adopts the above-described backlight module in accordance with the present invention. The glass substrate of the backlight module is the TFT glass substrate of the liquid crystal display screen, and the light exiting surface of the glass substrate is formed with a TFT array.

Accordingly, the backlight in accordance with the present invention no longer uses the conventional light guide plate and even the optical film set in some embodiments, the cost of product is reduced. Moreover, on the perquisite of achieving backlight effect, the optical paths of light rays propagating in the conventional light guide plate and optical film set are reduced, the effect of increasing the utilization efficiency of light source is achieved and the quality of product is improved. In addition, since the backlight module dispenses the above-mentioned structural member(s) (e.g., the conventional light guide plate even the optical film set), an effect of reducing whole thickness of the liquid crystal display device can be achieved.

### BRIEF DESCRIPTION OF THE DRAWINGS

The above embodiments will become more readily apparent to those ordinarily skilled in the art after reviewing the following detailed description and accompanying drawings.

FIG. 1 is a schematic structural view of conventional backlight module and liquid crystal display screen.

FIG. 2 is a schematic structure view of backlight module and liquid crystal display screen in accordance with a first embodiment of the present invention.

FIG. 3 is a schematic structure view of backlight module and liquid crystal display screen in accordance with a second embodiment of the present invention.

FIG. 4 is a schematic structure view of backlight module and liquid crystal display screen in accordance with a third embodiment of the present invention.

### DETAILED DESCRIPTION OF EMBODIMENTS

The present invention will now be described more specifically with reference to the following embodiments. It is to be noted that the following descriptions of embodiments are presented herein for purpose of illustration and description only. It is not intended to be exhaustive or to be limited to the precise form disclosed.

As previously mentioned, the present invention addresses the drawbacks in the prior art to provide a backlight module including a rear plate, a reflective sheet, a glass substrate and a backlight source. The reflective sheet is disposed on the rear plate. The glass substrate is disposed on the reflective sheet. A surface of the glass substrate facing the reflective sheet is formed with an optical dot structure layer, and another surface of the glass substrate acts as a light exiting surface. The backlight source is disposed at a side of the glass substrate. The backlight source and the glass substrate have a first polarizer disposed therebetween. Light emitted from the backlight source becomes a polarized light after passing through polarizer, subsequently enters into the glass substrate, and then exits out from the light exiting surface after being reflected by the optical dot structure layer.

Moreover, the present invention further provides a liquid crystal display device including the above-described backlight module. The liquid crystal display device includes a liquid crystal display screen and the backlight module. The liquid crystal display screen at least includes a thin film transistor (TFT) glass substrate, a liquid crystal layer, a color filter (CF) glass substrate and a second polarizer arranged in that order. The glass substrate of the backlight module and the TFT glass substrate of the liquid crystal display screen are the same substrate, i.e., a glass substrate is formed with the optical dot structure layer of the backlight module on a surface and formed with a TFT array on another surface (light exiting surface).

With regard to the above described backlight module and liquid crystal display device of the present invention, the backlight module no longer uses the conventional light guide plate and even the optical film set in some embodiments, the cost of product is reduced. Moreover, on the perquisite of achieving backlight effect, the optical paths of light rays propagating in the conventional light guide plate and optical film set are reduced, the effect of increasing utilization efficiency of light source is achieved and thereby the quality of product is improved. In addition, since the backlight module dispenses the above-mentioned structural member(s) (e.g., the conventional light guide plate even the optical film set), an effect of reducing whole thickness of the liquid crystal display device can be achieved.

In order to better illustrate the technical features and structures of the present invention, various exemplary embodiments will be described below in detail with reference to accompanying drawings.

### First Embodiment

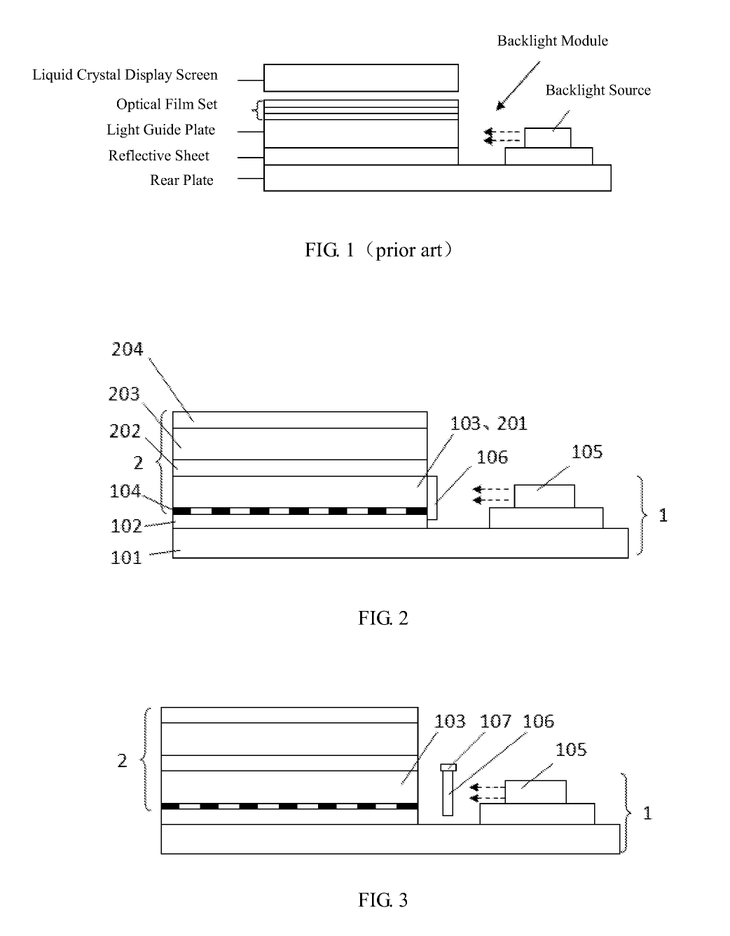

FIG. 2 is a schematic structural view of backlight module and liquid crystal display device in accordance with the first embodiment of the present invention. As illustrated in FIG. 2, the liquid crystal display device includes a liquid crystal display screen 2 and a backlight module 1. The liquid crystal display screen 2 at least includes a TFT glass substrate 201, a liquid crystal layer 202, a CF glass substrate 203 and a second polarizer 204 arranged in that order. The backlight module 1 includes a rear plate 101, a reflective sheet 102 disposed on the rear plate 101, a glass substrate 103 (being the same glass substrate with the TFT glass substrate 201 of the liquid crystal display screen 2) disposed on the reflective sheet 102 and, and a backlight source 105 disposed at a side of the glass substrate 103. A surface of the glass substrate 103 facing the reflective sheet 102, e.g., the bottom surface of the glass substrate 103 is formed with an optical dot structure layer 104, and another surface of the glass substrate 103, e.g., the top surface of the glass substrate 103 acts as a light exiting surface and is formed with a TFT array. The backlight source 105 and the glass substrate 103 have a first polarizer 106 disposed therebetween. In the first embodiment, the first polarizer 106 is directly pasted to the side surface of the glass substrate 103 and thus is tightly combined with the glass substrate 103.

The optical dot structure layer 104 for example is formed on the glass substrate 103 by a printing process or an etching process. Optical dots in the optical dot structure layer 104 are micro structures which can change propagation paths of light rays. A shape of each optical dot is not limited and as long as it can satisfy the processing convenience. A density distribution of the optical dots can be adjusted according to the demand of display brightness and uniformity. Generally, a region with dense optical dots would have a relatively high brightness, while a region with sparse optical dots would have a relatively low brightness.

In the first embodiment, the backlight source 105 for example includes multiple light emitting diodes.

Light emitted from the backlight source 105 becomes a polarized light after passing through the first polarizer, subsequently enters into the glass substrate, then is effected by both the optical dot structure layer 104 to become a uniform surface light perpendicular to the display surface, and thereafter exits out from the light exiting surface of the glass substrate 103. When the polarized surface light passes through the liquid crystal layer 202 between the TFT glass substrate 201 and the CF glass substrate 203, a polarity of the light is changed owing to the deflection of liquid crystal and thus the light can pass through the second polarizer 204, achieving the display function.

### Second Embodiment

FIG. 3 is a schematic structural view of backlight module and liquid crystal display device in accordance with a second embodiment of the present invention. As illustrated in FIG. 3, a difference from the first embodiment is that: the first polarizer 106 in the second embodiment is fixed at the side of the glass substrate 103 with a certain distance by a fastener 107, i.e., the fixed location of the first polarizer 106 is between the glass substrate 103 and the backlight source 105 and spaced from the side surface of the glass substrate 103 with the certain distance. The presence of the certain distance distant from the side surface of the glass substrate 103 facilitates the first polarizer 106 to be fixed and thereby achieving a satisfactory stability. A structure of the liquid crystal display screen 2 of the liquid crystal display device and other structures of the backlight module 1 are the same as that of the first embodiment.

### Third Embodiment

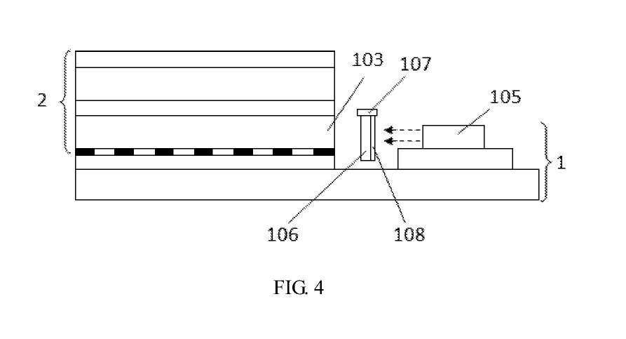

FIG. 4 is a schematic structural view of backlight module and liquid crystal display device in accordance with a third embodiment of the present invention. As illustrated in FIG. 4, a difference from the second embodiment is that: in the third embodiment, the first polarizer 106 and the backlight source 105 have an optical film set 108 disposed therebetween. In other embodiment, the optical film set 108 can be disposed between the first polarizer 106 and the glass substrate 103 instead. Moreover, the optical film set 108 can be a diffuser sheet, a prism sheet or an anti-reflective film, or any combinations of the diffuser sheet, the prism sheet and the anti-reflective film. A structure of the liquid crystal display screen 2 of the liquid crystal display device and other structures of the backlight module 1 are the same as that of the second embodiment.

In the third embodiment, the optical film set 108 disposed between the first polarizer 106 and the backlight source 105 can improve the quality of light emitted from the backlight source 105 and increase the backlight efficiency of the whole backlight module. Furthermore, compared with the optical film set used in the prior art, an area of the optical film set employed in the third embodiment is dramatically decreased and thus the cost of product is reduced.

In summary, with regard to the backlight module and the liquid crystal display device in accordance with the present invention, the backlight module no longer uses the conventional light guide plate and even the optical film set in some embodiments, the cost of product is reduced. Moreover, on the perquisite of achieving backlight effect, optical paths of light rays propagating in the conventional light guide plate and optical film set are reduced, the effect of increasing utilization efficiency of light source is achieved and the quality of product is improved. In addition, the backlight module dispenses the above-mentioned structural member(s) (e.g., the conventional light guide plate even the optical film set), an effect of reducing whole thickness of the liquid crystal display device can be achieved.

It is indicated that, in this specification, the relational terminologies such as “first” and “second” only are intended to discriminate an entity or operation from another entity or operation, and not necessarily to require or imply these entities or operations having actual relationships or orders existed therebetween. Moreover, the terminology of “including”, “containing” or variations thereof is meant to cover non-exclusive inclusion, so that a process, method, article or apparatus including a series of items not only includes listed items but also includes other item(s) not being explicitly listed or inherent item(s) of the process, method, article or apparatus. In the absence of more restrictive conditions, the item limited by the phraseology “including one” does not exclude the existence of additional identical item(s) in the process, method, article or apparatus including the item.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module comprising:
a rear plate;
a reflective sheet, disposed on the rear plate;
a glass substrate, disposed on the reflective sheet, wherein a surface of the glass substrate facing the reflective sheet is formed with an optical dot structure layer, and another surface of the glass substrate acts as a light exiting surface; and
a backlight source, disposed at a side of the glass substrate, wherein the backlight source and the glass substrate have a first polarizer disposed therebetween and thereby light emitted from the backlight source becomes a polarized light after passing through the first polarizer, subsequently enters into the glass substrate and then exits out from the light exiting surface after being reflected by the optical dot structure layer.

2. The backlight module according to claim 1, wherein the first polarizer is pasted to the side of the glass substrate.

3. The backlight module according to claim 1, wherein the first polarizer is fixed at the side of the glass substrate with a distance spaced from the glass substrate by a fastener.

4. The backlight module according to claim 1, wherein the optical dot structure layer is formed on the glass substrate by a printing process or an etching process.

5. The backlight module according to claim 1, wherein the first polarizer and the backlight source have an optical film set disposed therebetween.

6. The backlight module according to claim 5, wherein the optical film set is selected from the group consisting of a diffuser sheet, a prism sheet, an anti-reflective film, and any combinations thereof.

7. The backlight module according to claim 1, wherein the first polarizer and the glass substrate have an optical film set disposed therebetween.

8. The backlight module according to claim 7, wherein the optical film set is selected from the group consisting of a diffuser sheet, a prism sheet, an anti-reflective film, and any combinations thereof.

9. The backlight module according to claim 1, wherein the backlight source comprises a plurality of light emitting diodes.

10. A liquid crystal display device comprising a liquid crystal display screen and a backlight module, wherein the liquid crystal display screen at least comprises a TFT glass substrate, a liquid crystal layer, a color filter glass substrate and a second polarizer arranged in that order, the backlight module comprises:
a rear plate;
a reflective sheet, disposed on the rear plate;
a glass substrate, disposed on the reflective sheet, wherein a surface of the glass substrate facing the reflective sheet is formed with an optical dot structure layer, and another surface of the glass substrate acts as a light exiting surface;
a backlight source, disposed at a side of the glass substrate, wherein the backlight source and the glass substrate have a first polarizer disposed therebetween and thereby light emitted from the backlight source becomes a polarized light after passing through the first polarizer, subsequently enters into the glass substrate and then exits out from the light exiting surface after being reflected by the optical dot structure layer;
wherein the glass substrate of the backlight module is the TFT glass substrate of the liquid crystal display screen, and the light exiting surface of the glass substrate is formed with a TFT array.

11. The liquid crystal display device according to claim 10, wherein the first polarizer is pasted to the side of the glass substrate.

12. The liquid crystal display device according to claim 10, wherein the first polarizer is fixed at the side of the glass substrate with a distance spaced from the glass substrate by a fastener

13. The liquid crystal display device according to claim 10, wherein the optical dot structure layer is formed on the glass substrate by a printing process or an etching process.

14. The liquid crystal display device according to claim 10, wherein the first polarizer and the backlight source have an optical film set disposed therebetween.

15. The liquid crystal display device according to claim 14, wherein the optical film set is selected from the group consisting of a diffuser sheet, a prism sheet, an anti-reflective film, and any combinations thereof.

16. The liquid crystal display device according to claim 10, wherein the first polarizer and the glass substrate have an optical film set disposed therebetween.

17. The liquid crystal display device according to claim 16, wherein the optical film set is selected from the group consisting of a diffuser sheet, a prism sheet, an anti-reflective film, and any combinations thereof.

18. The liquid crystal display device according to claim 10, wherein the backlight source comprises a plurality of light emitting diodes.
